(19) United States
(12) Patent Application Publication
(10) Pub. No.: US 2010/0071705 A1
(43) Pub. Date: Mar. 25, 2010

(54) ARCH SUPPORT FOR THE HUMAN HAND

(76) Inventor: Todd Alexander Alviso, Yucca Valley, CA (US)

Correspondence Address: Todd Alviso, Suite #205, 555 South Sunrise Way, Palm Springs, CA, 92264, US

(21) Appl. No.: 12/558,493

(22) Filed: Sep. 12, 2009

Related U.S. Application Data
(60) Provisional application No. 61/191,907, filed on Sep. 12, 2008.

(51) Int. Cl. A61G 99/00

(52) U.S. Cl. 128/845

(57) ABSTRACT

A means for providing support to the human hand, by providing a domed protuberance, or eminence, shaped to support the palmar aspect of the human hand, having a raised portion (1) and optional base portion (3) for supporting or providing tactile comfort for the wrist, forearm, fingers and thumb. The device, in the typical embodiment, is made of a flexible material so that it can absorb impact forces upon pressure, without causing potential harm to the tissues that the device comes into contact with through touch. A plurality of bumped eminences (7, 5) may help to improve tactile forces, provide comfort, grip, relative dynamism, and may improve circulation, as opposed to a smooth surface. The device can rest upon a flattened surface such as a table, a desk, the floor, or even a bed, providing support for the anatomical structures of the human hand, most especially, the boney architecture, once the hand is placed in contact with the supporting device.

### CROSS REFERENCE TO RELATED APPLICATIONS

This patent application claims the benefit of co-pending provisional patent application # 61191907, filed with the United States Patent and Trademark Office on Sep. 12, 2008, by Todd A. Alviso.

### BACKGROUND

1. Field of Invention

This invention relates to arch supports for the human hand, specifically such supports which are to be used for supporting the hand when sleeping in bed at night, or when sitting, or standing, with the hand resting upon a desk, a table, or any surface that the hand comes to rest upon, during typical human activities of daily living.

2. Description of Prior Art

Many people today understand the benefit of utilizing arch supports for human feet. Various arch support designs, utilizing various material densities and durometer combinations have been provided to people suffering from fallen foot arches, and other related biomechanical deficits. However, many people today, may not realize the importance of maintaining the arches of the human hand, by providing a similar support mechanism for use during some typical human activities of daily living.

While the preference for some support to the human hand has been utilized in the computer industry with the dome shape of various designs of the computer mouse, support for the relatively static hand, when placed to rest upon variable surfaces has not been provided. Today's modern day environment typically provides relatively hard, flat, unnatural surfaces, such as tables or desks, that a user interacts with, by at times, placing and resting their hands upon such surfaces, while performing work. Similar to hard flat, unnatural ground surfaces, contributing to the deformation of human feet in various manners, relatively hard, flat, unnatural surfaces in general, when interacting with the multiple arches of the human skeletal frame, including the hands, would appear to have similar deleterious effects upon human tissues. This re-modeling, or deformation of human tissue, due to such adverse biomechanical and tactile forces, occurs under the physiological law in the human body known as Wolf's Law of Bone and Soft-tissue Remodeling. Wolf's Law states that bone and soft-tissue remodel according to the stresses imposed upon the tissues. Henceforth, inappropriate forces, such as relatively hard, flat, unnatural surfaces, when interacting with the human body, would seemingly effect the formation of the hard and soft-tissue elements of the body. The human hand has been commonly associated with deformation, as has the human foot. Interaction with hard, flat, unnatural surfaces, by the human hand, as described herein, is therefore, an issue that may be addressed through mechanical and tactile measures, as proposed in the invention set forth within this application.

While it is relatively common to support the hand to some degree, by various means provided by the medical community, including splints, casts, and gloved support measures, there has not been a free standing arch support, primarily supporting the various arches of the human hand, which is not attached to the human body. Additionally, there has not been an arch support for the hand that is designed for general everyday, use as a preventative, as well as a therapeutic measure. Previous uses have typically been for post-surgical support, or post-injury recovery. Such continuous supports worn on the body may have a negative effect on biological tissues if continued indefinitely, in accordance with Wolf's Law of Bone and Soft-tissue Remodeling, as the tissues will begin to atrophy and lose their function and overall strength, if placated with relatively constant support. Therefore, typically, hand supports and splints are not worn on a regular basis as their preventative measures are limited by Wolf's Law.

The anatomical structures, physiological functions, including the biomechanical action and reaction forces of the human body's interaction with various forces have been understood to a great degree by medical and health professionals, anatomists, and physiologists for years. However, the relative tissue tolerances for man and woman's modern day, unnatural activities, that continue to evolve over time with the advancement of technologies, has not been specifically determined. Some activities, while being done for many years, by many people, such as resting a hand upon a hard, flat unnatural, surface such as a table, desk, etc . . . , and the effects that such acts may have on the anatomical structures of the human hand, in accordance with Wolf's Law of Bone and Soft-tissue Remodeling, has not been specifically determined for all interactions. If these forces and tissue tolerances were truly appreciated, or known before, certainly some devices, similar to the one described within this invention, would have been implemented by now. However, there has not been such a device, and their has not been any direct informational campaign that describes these factors of the human hand's interaction, with static, non-yielding, unnatural, hard, flat surface environments, as described herein. Newton's Third Law of Reaction States that, “for every action there is an equal and opposite reaction,” and the equal and opposite reaction to a hard, flat, unnatural desk, floor, table, or other like surface, may indeed be, given enough time, a relatively, hard, flat, unnatural hand and soft-tissue structures, even permeating into other regions of the body, contributing to aberrant biomechanics. The typical osteoarthritic hand, with various anatomical deviations from the norm, is such an example, of such a described altered anatomical structure. Just as inappropriate footwear, and hard, flat unnatural surfaces, may contribute to arthritic deformity in the local anatomical structures of the feet, so can their effects, most likely be transmitted throughout the kinematic chain of the human body, to other distal or seemingly remote structures. This basic law of physics, from Sir Isaac Newton, coupled with Wolf's Law of Bone and Soft-tissue Remodeling, provides a foundation, based in physiological and anatomical laws of tissue reformation and deformation, for understanding the most common of all deformities to effect the human body, osteoarthritis, also know as the wear and tear arthritis. Natural surfaces provide irregular surfaces, of various densities for the human body to interact with, lending to a human structure that is relatively healthy and strong, in its most natural intended structure and physiology. The adaptive human body, in today's modern day environment, filled with a tactile environment made to last, constructed of hard, flat, unnatural elements, forces the body into an unnatural, adapted state, both mechanically, anatomically, and eventually physiologically. Recognizing these forces as aberrant forces, may be the first step in the direction towards preventing these apparently acquired premature degenerative tissue changes, which appears to be caused at least in part, by a cause that is preventable, and in part may be addressed by the invention disclosed within this patent application, the human hand arch support device. The following is a review of the relatively natural intended design of the human hand, establishing some basic anatomical structures and biomechanical and physiological functions, previously known to the field of human health and biomechanics.

The human hand is made up of various biological tissues with various structural densities for providing dynamic equilibrium to the most tactile of all earthly species, in terms of precision manipulation for tool making. This is accomplished through the unique structure of the human hand, referred to as the opposable thumb. While this thumb is typically able to oppose all 4 fingers, it is vulnerable to wear and tear arthritis, known as the osteoarthritis, hosting one of the most commonly afflicted joints in the human body, the first metacarpophalangeal joint. The anatomical structures as described herein, are referenced from the known study of the human body, referred to as the anatomical position. Those practiced in the art will understand the referenced anatomical planes, determining, specific anatomical locations. The anatomical and physiological study of the human hand begin at it's foundation for all tissues in the human body, the boney architecture. The forearm is made up of the radius and ulna, two long bones that begin in the elbow, and extend distally, terminating with cartilaginous end caps that articulate with the human wrist. The radius and ulna articulate, forming a joint, with a few bones, from the group of bones known as the carpals. They consist of the scaphoid, lunate, triquetrum, pisiform, hamate, capitate, trapezoid, trapezium. The first metacarpal consist of a base, a shaft and a head. The base of the first metacarpal articulates with the trapezium, trapezoid and 2^{nd} metacarpal. The head of the first metacarpal articulates with the proximal phalanx of the thumb. The proximal phalanx of the thumb then finally articulates with the distal phalanx of the thumb.

Four more metacarpal bones articulate with each other, as well as with several of the carpals. All metacarpals also have a base, a shaft and a head. The base generally articulates with the carpals, and the head with the proximal phalanx bones of each finger. Each proximal phalanx has a base, a shaft and a head. All four fingers also have a middle phalanx, which also has a similar base, shaft and head, like the proximal phalanx. The middle phalanx articulates at its base with the proximal phalanx heads, and articulates at the middle phalanx head, with the distal phalanx base. All four fingers have a distal phalanx.

Various ligaments, joint capsules, tendons, fascia, with its various layers of connective tissues, as well as muscle and fatty tissues surround the osteological structures, in order to help protect, support, and provide, dynamic equilibrium to the skeletal structures, to allow for both dynamic, as well as relatively static support. Additionally, circulatory vessels, including blood and lymphatic vessels, traverse the boney architecture, piercing through various soft-tissue structures, supported in the various layers of fascia. Included in these circulatory routes, are the nerve vessels. The nerve vessels may also be subject to pathology, when faulty alignment of the hand structures occurs. Proper alignment of all anatomical structures, is essential to maintaining optimal joint health for an individual's particular age, while, providing protection of vital circulatory as well as neural elements. Nerve as well as circulatory compression has been well documented in the medical literature, as an adaptive, acquired condition in many instances.

When viewing the boney architectural alignment of the human hand from the medial side view of the hand, if the hand is placed in a relatively pronated, palms down toward the table position, the hands naturally arched boney architecture is evident. The apex of the arch created by the boney architecture of the palmar aspect of the human hand may be primarily considered to be located at the articulation, or joint line between the head of the metacarpals of the four fingers, and base of the proximal phalanx bases of the four fingers. This is an essential area to support, in order to maintain proper arch hand alignment.

As previously stated, sustained static, unsupported interaction between these aforementioned joints at the apex of the palmar aspect of the arch of the human hand, when placed under sufficient, sustained load, may become vulnerable to bone and soft-tissue deformation, in accordance with Wolf's Law of Bone and Soft-tissue Deformation, and Newton's third Law of Reaction. These laws will be discussed in the disclosure below, however provide a basis for the practical application to the invention contained herein, of the relatively free-standing, human hand arch support device.

While the computer mouse and some medical supports and splints for the human hand have provided their varied functions, they all are known to suffer from a number of disadvantages, when it comes to providing support for the human hand on a regular basis, for both static and dynamic operations:

(a) A computer mouse, can provide some support to the hand during computer mouse operation, but it does not provide support for the resting or dynamic hand, that may bear significant upper body weight, for instance, when pushing off from a desk, a table, or even a floor, with the hands upon standing.

(b) The relatively hard, smooth surface on top of a mouse may not allow for maximum circulation of tissues, as such a surface may create “flattened areas” of tissues resting upon the hardened surface of the mouse.

(c) Using a computer mouse with one hand, and not supporting the other, can contribute to further bone and soft-tissue imbalances between the left and right sides of the body, contributing to asymmetry.

(d) Resting, and or putting pressure on the hand, by acting upon a relatively hard, flat, unnatural surface, without additional hand arch support as proposed in the invention disclosed herein, may contribute to bone and soft-tissue deformities of the hand, and upper extremities, extending potentially throughout the body.

(e) Hand supports and or splints, that are worn indefinitely on the body, can have a weakening effect upon the tissues, and are therefore contraindicated for continuous support, or as a preventative measure for relative hand deformity, due to subtle cumulative traumatic changes.

### OBJECTS AND ADVANTAGES

Several objects and advantages of the present invention are:

(a) to provide an arch support device for the human hand, the method of use not requiring the individual utilizing the support, to wear the support;

(b) to provide an arch support device for the human hand, the method of use providing the individual with a free standing arch support that can be placed upon any surface, and used as often as needed;

(c) to provide an arch support device for the human hand, the method of use providing the individual with the ability to rest their hand comfortably, with improved tactile and biomechanical forces transmitted to the human hand;

(d) to provide an arch support device for the human hand, the method of use providing the individual with the ability to more comfortably apply increased pressures upon the hand when pushing off from a desk, a table, the floor, or the like, by improving the support to the bony architecture of the human hand;

(e) to provide an arch support device for the human hand, the method of use providing the individual with an enhanced sense of tactile comfort, and improved proprioceptive input to the hand structures;

(f) to provide an arch support device for the human hand, the method of use providing the individual with improved hand arch shape, and the potential for circulatory benefits, as well as preventative measures, that would appear to occur from maintaining the arches of the human hand, when resting the hand with the hand arch support invention, upon a typical, relatively, hard, flat, unnatural surface, or other relatively flat surfaces, whether or not they are hard or soft in durometer;

(g) to provide an arch support device for the human hand, the method of use providing the individual with an improved, or supported, hand arch shape when lying down in bed to sleep, or rest, thus providing less tension on the hand than that which typically with occurs with an outstretched hand, thereby assisting with improved rest, and the potential for improved respiratory ease, through the relaxed hand posture.

Further objects and advantages will become apparent from a consideration of the ensuing description and drawings of the invention.

### DRAWING FIGURES

In the drawings, closely related figures (Fig.) have the same number but different alphabetic suffixes.

FIG. 1A to 1C shows various aspects the support with the human hand.

FIG. 2A to 2E shows a various aspects of the support without the human hand.

FIG. 3A to 3C shows various aspects of the support with extended support base and wrist support.

FIG. 4A to 4D shows two embodiment of an extended base support and or cushioning.

FIGS. 5A and 5B shows another embodiment of the device with raised bumps.

FIG. 6A to 6C shows various hand positions for performing the method of the first metacarpophanlangeal joint flexion and extension exercises of the thumb on the device.

### REFERENCE NUMERAL IN DRAWINGS

1 hand arch support
2 left hand
3 extended base
4 wrist support
5 extended base bumps
6 hand arch support with bumps
7 hand arch support bump
8 starting position of thumb
9 flexion position of thumb
10 extension position of thumb
11 right hand

### SUMMARY

In accordance with the present invention, a device used to support the arches of the human hand comprises of a device shaped to support the bone and soft-tissue structures of the human hand, essentially maintaining the natural arched shape of the palmar aspect of the hand, providing a relative gripping surface for the hand to rest upon, and or apply some pressure upon, whereby the arches of the hand maintain a relative domed, arched shape, causing a cupping of the palmar aspect of the hand, providing rest and secondary support to the human hand, enhancing its normal biomechanical actions, upon interaction with a relatively, hard, flat, unnatural surfaces, and or softer, relatively flat surfaces, such as a bed, or the like, that the human hand may come into contact with during normal activities of daily living.

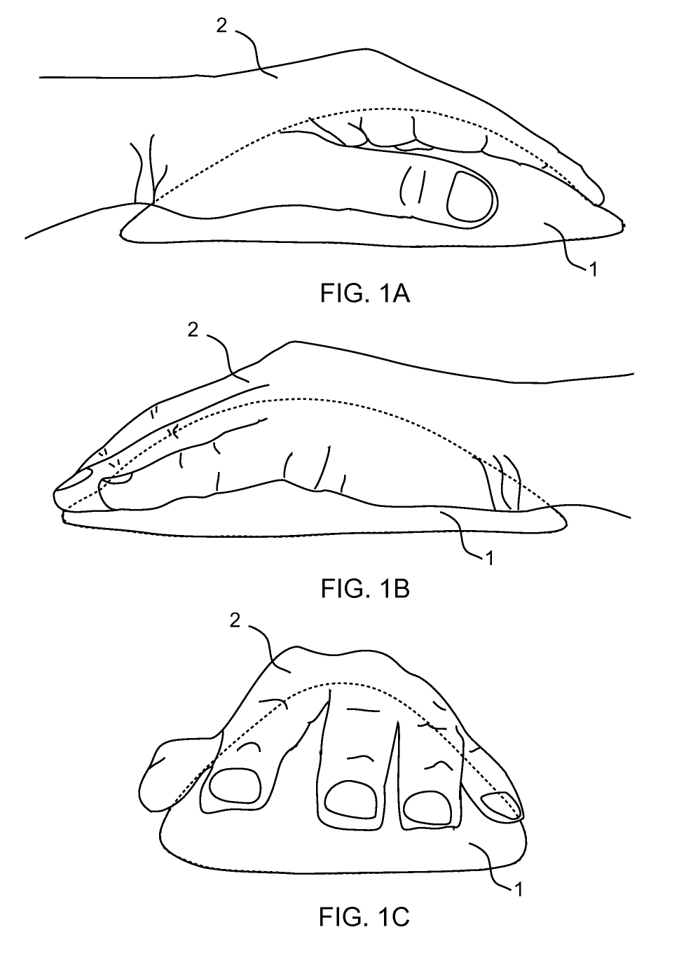

### DESCRIPTION—FIGS. 1 TO 6

A typical embodiment of the hand arch support device of the present invention is illustrated in FIG. 1A (thumb side view), FIG. 1B (5^{th} digit side view), and FIG. 1C (front end, finger tip view), with the left hand situated to rest upon the device. In a typical embodiment, the hand arch support 1 has a asymmetrically domed shape, providing a graduating rising slope over the longitudinal distance of the support. This shape generally conforms to the palmar arch side of the human hand to provide support for the entire hand. The support is designed for either the left or right hand, with a symmetrical side to side shape, providing for a variety of individual user hand positions on the device, so as not to lock the hand in any one position. FIG. 1A to 1C demonstrates the general position of the left hand 2 of an individual user, resting the hand on support device 1. Notable, the device may be turned around, so that the opposite ends of the device may be positioned beneath the hand, in order to provide a different resting position for the hand, in order to also help promote dynamic positioning, at times, to further help any positional fatigue, which may occur from holding the hand in any single position for an extended period of time. This positional change of the device can be accomplished with other embodiments of the device as well.

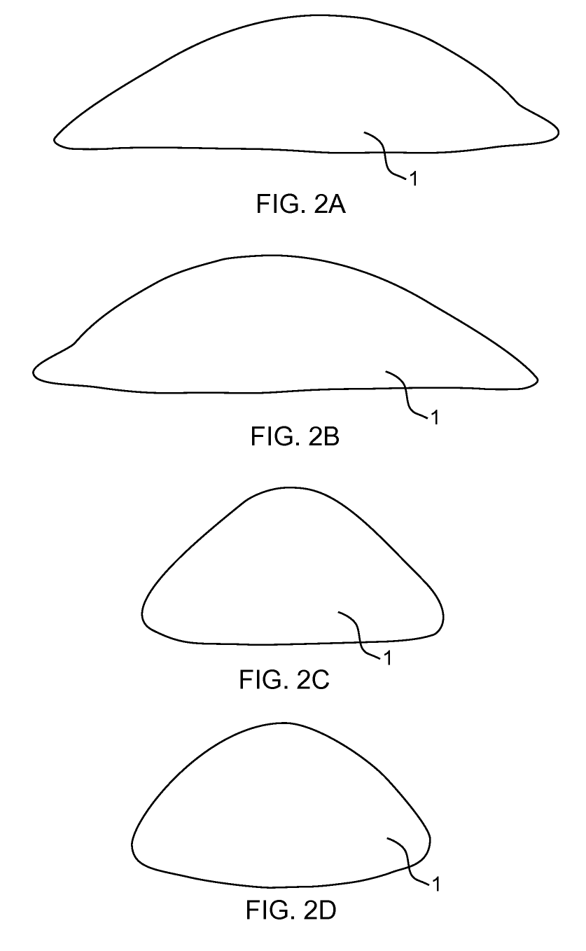

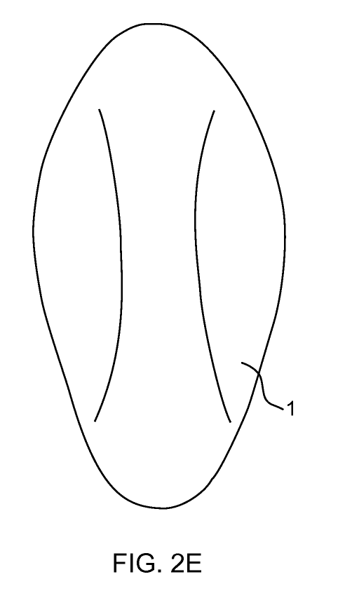

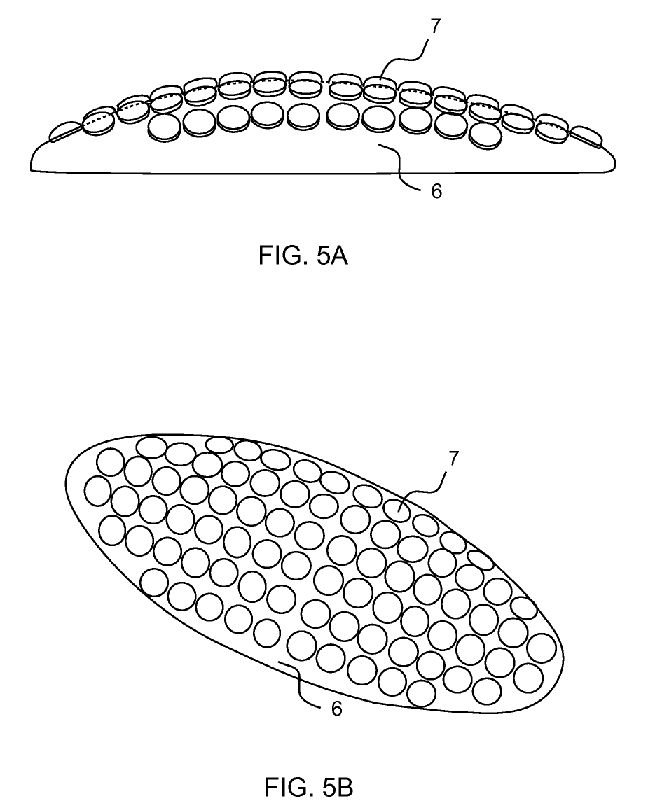

Additional images of the typical embodiment of the device, without the hand in place are seen in FIG. 2A (side view), FIG. 2B (side view), FIG. 2C (anterior view), FIG. 2D (posterior view), and FIG. 2E (top view). The relative size, shape, and surface texture, and or architecture of the typical embodiment can vary as is seen in FIG. 5A (side view), and FIG. 5B (posterior superior oblique view), without the hand in place. This variation in size and shape, of the hand arch support 6 helps to accommodate various hand sizes, and or, relative hand shapes, based on the level of deformity that has already set into a maladapted, or relatively deformed human hand, when compared to the anatomical normal. Raised bump 7 can be distributed in various numbers and sizes, forming a plurality of bumps on the surface of the support 6, in order to provide improved tactile forces, relative dynamism, improved grip and potential circulatory efficiency, and comfort. In the typical embodiment with bumps, and applicable to all embodiments if desired, small half-sphere-like, dome shaped bumped structures 7, typically between 4 and 6 mm in diameter, and approximately 2 mm in height, are included on the surface of the raised domed support, in order to potentially improve circulation of the supported anatomical structures, as well as to add some dynamic component to the various hand and or forearm, wrist, postures, or positions an individual user of the product may assume. The bumped structures 7, may be more or less numerous, with smaller or larger diameters and heights.

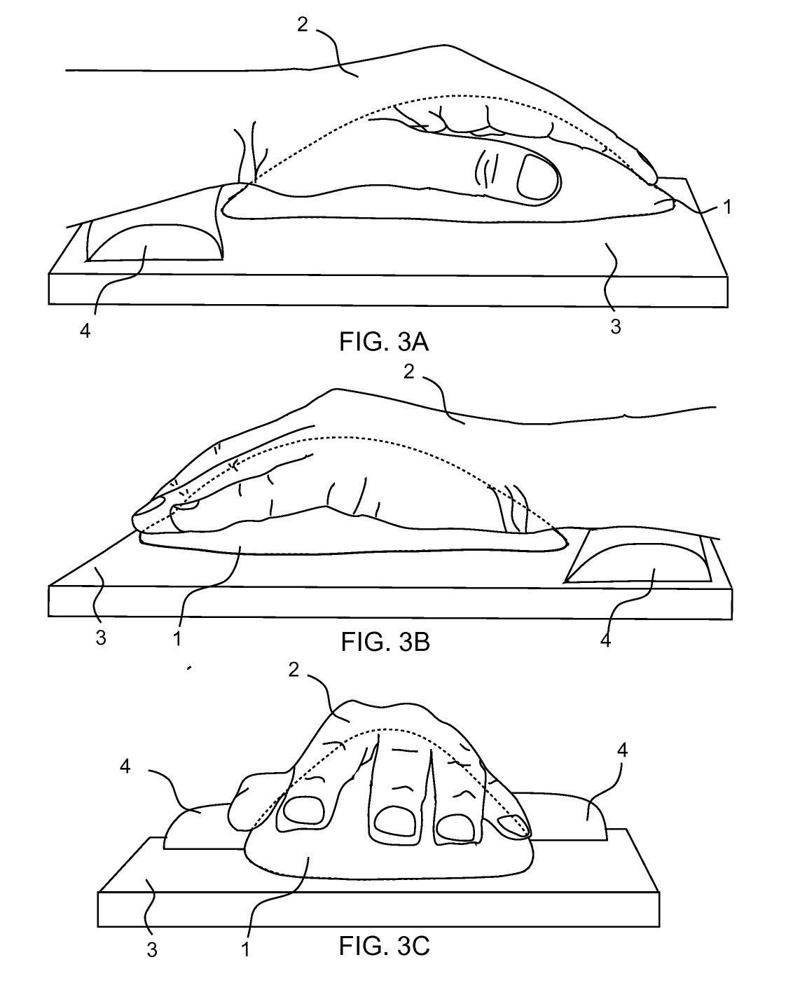

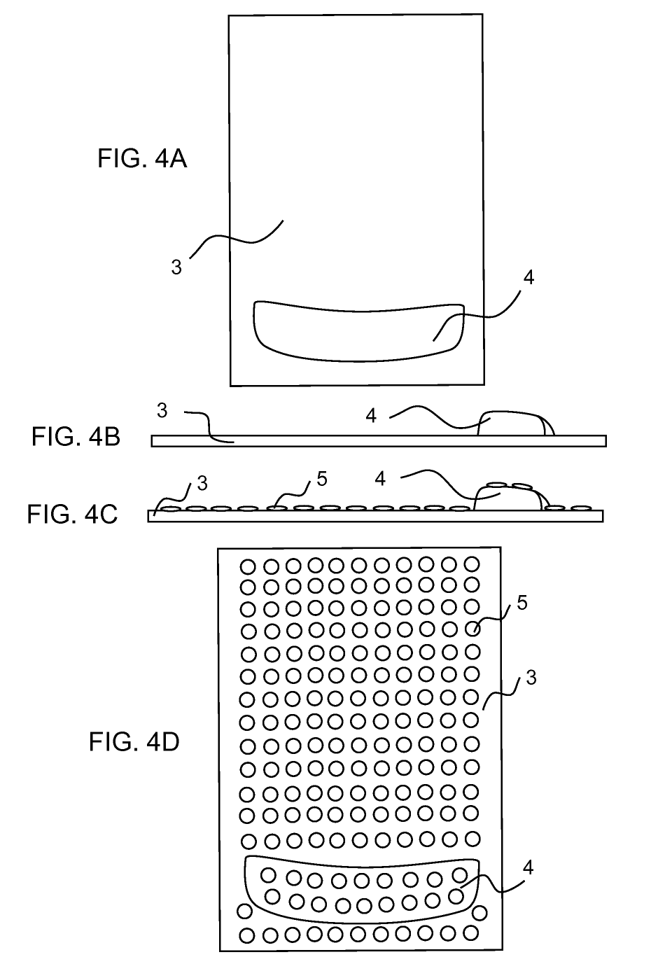

FIG. 4A (top view), FIG. 4B (side view), FIG. 4C (side view), and FIG. 4D (top view) show and extended optional base that may be provided underneath the hand arch support device. The arch support may have a base 3 of essentially uniform cross section thickness consisting of a cushioned sheet of material, with or without wrist support mound 4. Wrist support mound 4 is also a cushioned material. The top surface may be smooth or with a texture, and may have a series, or plurality of bumps 5 on the top surface. Raised bump 5 can be distributed in various numbers and sizes, on the surface of the cushioned sheet, in order to provide improved tactile forces, relative dynamism, improved grip and potential circulatory efficiency, and comfort. There may be a variety of textures that could be applied to the top surface of the domed support or to the base, during the mold making process, in order to produce an essentially slightly irregular surface texture, for improved comfort to anatomical tissues. While the cushioned sheet base 3 can be of a relatively equal cross-sectional thickness, it can have an irregular top surface applied either as a mold texture as previously described, or it can be cast relatively irregular on the surface itself, providing a more natural surface contact for the human body. Extended base sheet 3 may have a rubber, or similar material backed surface to prevent slipping, when placed on a surface, or may be of a relatively slick material, such as a smooth-backed surface, made of a relatively harder cast polyurethane material of a durometer such that the material can move freely upon the surface it is in contact with during operation. The back side, or table, or desk, or like object surface side of the hand arch support 1 or extended base 3 may have an adhesive back for attaching to various structures for stability. This may be a peel away cover on the back which exposes adhesive to then attach to another object or structure. The back or bottom surface can be of a harder or softer material as well, that can provide similar properties as preferred, such as a woven fabric, silk, cotton, vinyl, nylon, leather, or can be simply the backside of the polyurethane molded part base and or dome, consisting of either an elastomer, or a polyurethane foam, or thermoplastic rubber material, or silicone, or similar materials selected to provide comfort and support to the user. Additionally, a texture may be applied to the backside surface, in order to help provide either a rougher or a mother surface, for either more or less grip, as preferred. The extended base 3 may extend beyond the area of the hand to provide some cushioning effect to the forearm and wrist, or the finger tips, if the hand is positioned in such a manner. The extended base 3 may be post-applied through gluing to the hand arch support, or may act as a separate piece, allowing the hand arch support to move freely upon the extended base 3 as the user wishes, providing a number of different hand and wrist and forearm positions. Extended base 3 may also be molded with the hand arch support in a single piece, providing both the hand arch support, with the extended base, made of the same material. The devices can also be constructed as a two part material process, in order to add some improved dynamics to the device. The extended base 3 could be made of another material density or durometer, either softer or harder than a second material density or durometer of the dome-like eminence for supporting the palmar arch of the human hand, which could be placed upon the extended base 3, and either cemented together with hand arch support 1, in a post application process. Once again, hand arch support 1, and extended base 3 could have various textured surface materials, from the dome shaped bumps, to various irregular patterns for comfort. Various molding processes for the various embodiments may be implemented depending on the final materials and design desired. These process are well-known to those skilled in the art of molding different types of rubber processes, or polyurethane and or similar material mold-making and part production. FIG. 3A (thumb side view), FIG. 3B (5^{th} digit side view), and FIG. 3B (end view) show the extended base 3 with wrist support mound 4, and the left hand situated to rest upon the device.

The hand arch support extends upwards in the region that is designed to contact the arched area in the palm of the hand. The average height of such an inclination would vary according to user hand size and a device selected for an individuals, size hand, but approximately an apex height of between 30 to 50 millimeters (mm) in height would be suffice. The dome or protruding eminence most from the hand arch support could vary in its length and width, again accommodating the users hand size, but a typical eminence may rise to the dome shaped top surface from the bottom surface of the support which is approximately 165 mm in length, and at its widest, approximately 85 mm in width. The width would accommodate the distance across the hand from the thumb to the fifth digit or little finger, while the length would accommodate typically from the base of thenar and hypothenar pad of the hand, representing the approximate base of the metacarpals, extending in length towards the distal aspect of the fingers, terminating at various distances, depending on the embodiment of the device selected by the user, and or their particular hand size. While the length of the support provided by the protruding eminence can vary, all embodiments, would specifically, and primarily support the region of the hand that the device is designed to support in the palmar aspect of the hand, located at the apex of the boney architectural alignment of the primary arch of the human hand, consisting of the joints located at the head of the metacarpals of the four fingers, and the base of the proximal phalanx of the four fingers, as well as the proximal and distal phalanx of the thumb. The apex may also include the distal aspect of the metacarpal shafts and heads of the metacarpals themselves, as their support may also help to support the main arch of the palmar aspect of the hand. Additionally, tactile support is provided to the first metacarpophalangeal joint of the thumb.

The material and durometer of the dome shaped eminence portion of the device, designed to support the palmar arch, and or fingers and thumb, as well as the base, may be made of a polyurethane foam material with a skin, or may be an elastomer, a polyurethane gel, a thermoplastic rubber, silicone, or any rubber, or any material that can provide sufficient comfort and support the anatomical structures of an individual during use of the device for comfort and support. Sample durometer of material for example may be a skinned polyurethane foam or an elastomer, of a durometer of approximately between 20 and 65 shore C durometer would be suffice. Softer or harder durometer or densities may be more or less depending on the embodiment, such as a pillow formed into the general shape of device, or a solid non-yielding support, that has greater durability. The durometer and material in a typical embodiment are similar to that used in PU foam insoles for the footwear industry, and therefore, could have similar variety of durometers depending on the level of support selected. Upon touch with the device, the hand may rest comfortably, but upon pressure, the device, or support, may give way to some degree, as a result of the foam, and or foam or rubber-like, material selection. This relatively dome shaped protuberance, may take several forms. It may be of a simple architecture such as a dome, a spherical structure, a half ellipsoid shaped type structure, or a specific, shape, made to conform to the palmar aspect, made either, custom for an individual's hand, or made non-custom, in various sizes, in order to accommodate, various hand sizes. Nonetheless, all aforementioned structures that shape the protuberance, dome or mound, for the palmar surface of the hand to rest upon, are relatively shaped to conform to the palmar arch of the human hand and to provide either partial or full finger, and thumb support depending on the specific design, of the functionally, unique, free-hand support designed for specific functions as described in this invention. The fingers may extend outwards beyond the dome or dome-like shaped eminence, and come to rest on the base 3 for some cushioned support to the fingers. Additional embodiments of the device, may provide an extended dome that continues outwards, towards the tips of the fingers, and somewhat outwards for the thumb, in some designs, in an effort to support the fingers and thumb in a more open-palm position.

With regards to manufacturing, in-mold color coating, using a pigmented mold-release, can help to provide a variety of colors with good surface color uniformity to the foaming polyurethane process. Additionally, surface materials may be added to provide a fabric type top surface to the device, made of woven fabric, nylon, cotton casing, similar to a pillow case, or other man-made materials. While a base 3 may be preferred by some, it is not necessary, and the device can be limited to a protruding dome-like shaped eminence, hand arch support 1 as described above, designed to conform to the human hand, most specifically with the palmar arch of the human hand, and in some embodiments of the device, including the fingers, and or thumb.

The device may also be incorporated into a desk mat, typically provided for added comfort, while working at the desk, when provided with the flattened side pads of the desk pad or mat. Adding the human hand arch support to an existing object, such as a desk pad, may add convenience as well as improved comfort level for the typical desk or office worker. Additional applications, or embodiments, may include a place mat for a table, that also has the human hand arch support co-molded to or post-applied, in order to provide comfort while eating. Other applications of the human hand arch support as described within this invention, may certainly apply to the functional anatomical support provided by the device described herein, and are not limited to the specific applications described herein.

### OPERATION—FIGS. 1, 3, 6

The manner of using the hand arch support device in order to support the bony architectural alignment of the human hand is described below, and shown in the referenced figures. Most specifically, and primarily, the region of the hand that the device is designed to support is at the apex of the boney architectural alignment of the human hand, consisting of the joints located at the head of the metacarpals of the four fingers, and the base of the proximal phalanx of the four fingers. The apex may also include the distal part of the metacarpal shafts and heads of the metacarpals themselves, as their support may also help to support the main arch of the palmar aspect of the hand. Additionally, tactile support is provided to the first metacarpal phalange joint of the thumb. When the user of the device is sitting at a desk or a table, they can simply rest there hand with the palm of the user's hand coming to rest upon the dome-shaped like eminence of the hand arch support device. The fingers and thumb can rest upon the support, as well as the table, desk, or the like, directly if no base is included in the device and the hand is positioned to contact the table, desk, or the like, or can rest upon the extended base 3, if included. With these several assumed hand postures on the device, individual, can simply continue to rest the hand upon the device, while they continue to do desk work, or various activities, or may increase the pressure into the device upon arising from the table, in order to gain leverage, upon standing. One or two devices can be used, depending if the individual wants to support one or both hands. Preliminary evidence has shown that maintaining palmar arch height of the hand has been shown to subjectively improve a relatively detectable respiratory ease. This is an important finding, and signifies in some terms, of the physiological benefits, from an improved palmar arch. This is physiologically plausible, as the bony architecture is interconnected, and just as rib alignment distortion, such as in cases of scoliosis, or a curvature of the spine, can cause respiratory distress, so too, may any misalignment from the natural intended design of the biomechanics of the human body, including the distal aspects of the extremities, most specifically the hands, and the feet.

A second usage of the device, previously mentioned, but detailed more herein, includes the same positioning of resting upon a desk or table, however, usage may continue when the individual attempts to arise from the seated posture form the desk. Typically people push off with one or both hands, in order to improve stability, as studies have shown such a contact may improve stability, however they typically create a unnatural biomechanical forces that interact with the human body and its tissues, when pushing off on a hard flat surface. This may contribute to fallen hand arches, similar to fallen foot arches. Therefore, with the hand arch support device described herein, the user can maintain their contact with the hand arch support device upon standing and improve their comfort level upon standing, as well as their stability, and hand arch shape upon push-off from the table, desk, or the like, while supported by the device. Similarly a hand arch support device that is placed on the floor, could be used to help an individual user to arise from the floor with the aid of the device. Using one device under each hand, depending on the embodiment of the device, may provide for improved arch hand support while doing certain floor exercises, including push-ups, an exercise where the outstretched hands are placed on the floor and the user pushes off with there hands and forearms to an extended position lifting the upper body off of the floor.

A third usage of this device, can be provided when the individual user lies down in bed. Just as the body pillow, a full-length pillow which may help comfort an individual when lying on a flat surface such as a bed, even though cushioned, may also help to improve respiratory ease by relatively opening up the ribs and pelvis, when compared to a folded relatively flat-lying position without such a pillow, the hand arch support, when used when lying in bed, can similarly provide relief to a hand that would otherwise be subject to deformation during sleep at night, while resting upon a relatively flat surface, such as a bed. Therefore, using the hand arch support device while lying in bed, can also similarly improve arch hand shape, and therefore, relatively improve respiratory ease as previously described, and in accordance with preliminary subjective test results. Once again, with either one or both hands in use, the user would rest the palm of their hand, and or fingers, and thumb, depending on the embodiment of the device used, on top of the dome shaped-like eminence of the hand arch support.

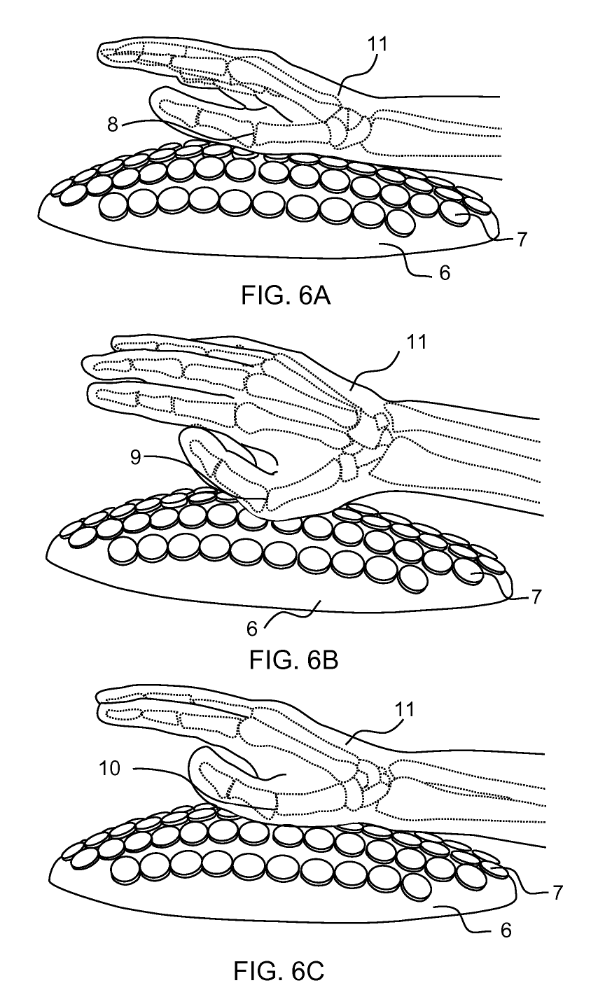

Another usage of the product hand arch support system may include positioning the first metacarpophalangeal joint of a hand on the surface of the device, comfortable resting the medial aspect of the thenar pad of the hand, most specifically toward the palmar aspect of the thumb, and performing a series of thumb motions, in order to help strengthen the surrounding muscles to one of the most commonly involved joints of the human body, that is afflicted with osteoarthritis. By performing a series of simple flexion and extension, abduction, adduction, and rotation exercises of the thumb, while being supported and relatively, compressed and aligned by positioning the joint, while maintaining some downward pressure may be beneficial to strengthening the joint structures and functions. FIG. 6A (thumb side view) shows the right hand of an individual user demonstrating the starting position for all exercises for the thumb described in this method of use. The first metacarpophalangeal joint 8 of the right hand 11 is shown resting on the top portion of the protuberance of the dome. FIG. 6B (Superior oblique thumb side view) show the active flexion position of the thumb, during the flexion motion. The first metacarpihalangeal joint is shown in the flexion position 9. Flexion also occurs at the joint between the proximal and distal phalanx of the thumb. FIG. 6C (superior oblique thumb side view) shows the active extension position of the thumb, during the extension motion. The first metacarpophalangeal joint in extension position 10 is shown. Other exercise motions begin from the same starting position 8 of the first metacarpophalangeal joint, and include such motions as abduction, adduction, and rotation, known motions to those studied and practiced in the arts and science of exercise physiology, or physical medicine studies.

No matter the final selected usage, as their applications may be broad, and are not limited by the specific device embodiments shown within this invention, the hand arch support device as described herein, would also seemingly improve the alignment of the upper extremities, head and neck structures, as a direct result of the alignment of the most distal aspect of the upper extremity, the human hand. This may be referred to as the kinematic chain of the upper body and extremities, and is based on the established biomechanical concepts that the structure of the body is directly related to its function.

### CONCLUSION, RAMIFICATIONS, AND SCOPE

Accordingly, the hand arch support device is a new approach to an age-old problem of cumulative trauma to the human hand structures. Cumulative trauma, caused in part, based on Wolf's Law of Bone and Soft-tissue Remodeling, by the human hand's interaction with hard, flat, unnatural surfaces, something nature never intended for direct interaction with the human body or any or its structures, including the human hand, has created numerous problems for the natural intended biomechanical, and hence physiological state of the human body. While we try to protect our feet with shoes, and their various support mechanisms against the hard, flat, unnatural surfaces that the human body chooses to walk upon, the human hand has been left bare, without support, and as a result may be suffering from an acquired mechanical deficit, subject to preventative measures, potentially provided by the hand arch support device disclosed herein the instant patent application. Furthermore, the hand arch support device has additional advantages in that:

1. it allows the human hand to maintain its natural intended alignment, by primarily supporting the boney architectural alignment of the human hand and soft tissue structures, improving circulation, and neural integrity, when compared to an unsupported, relatively flattened hand posture, when resting upon a table, a desk or a flat surface, or the like, including a softer surface such as a bed.

2. It provides a means for supporting the hand without attaching any elements to the human body, providing a free-standing, portable, intermittent hand arch support system.

3. It provides a comfortable, tactile interface, designed to promote ergonomic hand positioning, as well as long-term support for the problems associated with flat surface environments, including both hard and soft surfaces.

4. It provides an improved balanced upper body posture when seated or standing, either using a typical computer mouse, by supporting the opposite hand that is not utilizing the mouse, the user of the hand arch support device can provide a more symmetrical hand position, to that which is similar to the usage of the hand manipulating the computer mouse.

5. It provides a platform for positioning the first metacarpophalangeal joint of the base of the thumb, and for performing an improved, supported exercise motion to the surrounding muscles, in a relatively improved alignment state of the first metacarpophalangeal joint, commonly involved in osteoarthritis.

Although the description above contains many specificities, these should not be construed as limiting the scope of the invention, but as merely providing illustrations of some of the presently preferred embodiments of this invention. For example, dome-shaped protuberance of the hand arch support can have other shapes, such as circular, oval, hemispherical, half-egg-shape, etc . . . ; it also may include raised dome shaped bumps, or the like, or other textures that may create an irregular surface, or may even be smooth; it also may or may not have a supporting base that include some tactile comfort or support for the fingers, wrists, and forearms, depending on the size of the base; the device may also be made of different materials such as polyurethane foam with a skin, or an outer covering, similar to a pillow like material, or may be the polyurethane foam with its own skin, forming a relatively easy to clean durable lasting material, with dynamic properties, or any other like materials, or other varying material densities.

Thus, the scope of the invention should be determined by the claims of the patent application, and their legal equivalents, rather than by the examples given.

I, the applicant claim:

1. A device for contacting and supporting the human hand comprising a domed protuberance means that will provide support to the palmar arch aspect of the human hand, whereby the said hand contact support device is placed underneath the palmar aspect of the human hand, and said device is placed upon various surfaces, whereby said domed protuberance means helps to maintain the natural intended anatomical alignment of the bone and soft-tissue architecture of the human hand, during various activities of living.

2. The device of claim 1 wherein said domed protuberance means is composed of a resilient foam.

3. The device of claim 1 wherein said domed protuberance means is composed of a cross-linked polyethylene foam.

4. The device of claim 1 wherein said domed protuberance means is covered by a plurality of raised bumps, whereby hand grip and comfort is substantially improved.

5. The device of claim 1 whereby said domed protuberance means provides a means for performing specific hand exercises by positioning the first metacarpophalangeal joint of a hand on the surface of the device, and performing a series of simple flexion, extension, abduction, adduction, and rotation exercises of the thumb, thereby strengthening the surrounding soft-tissue elements.

6. The device of claim 1 whereby said domed protuberance means provides a predetermined support for the length of the hand, substantially supporting the palmar aspect of the hand, from the thenar and hypothenar pads to the tips of the thumb and fingers, including the apex portion of the palmar arch, consisting of the regions that include the joints located at the head of the metacarpals of the four fingers, and the base of the proximal phalanx of the four fingers, as well as the proximal and distal phalanx of the thumb, further including the distal aspect of the metacarpal shafts and heads of the metacarpals themselves, and the first metacarpophalangeal joint of the thumb.

7. The device of claim 1 wherein an extended base is provided, which may extend beyond the bottom surface of the said hand contact support device, whereby substantial cushioning is provided to the forearm, wrist, or the tips of the fingers.

8. A method for supporting the palmar arch of the human hand, comprising the steps of:
a. positioning the human hand on top of a dome-shaped eminence means, and
b. resting said dome-shaped eminence means on top of various substantially flat surfaces, whereby said dome shaped eminence means will support the human hand by providing a domed support surface for direct contact with the human hand, retaining the natural relatively concave surface of the palmar aspect of the human hand.

9. The method of claim 8, providing a plurality of raised bumps, whereby improved grip and comfort is provided.

10. The method of claim 8, providing an extended based contiguous with the bottom surface of the dome-shaped eminence means.

11. The method of claim 8, providing said dome shaped eminence means, composed of a resilient material.

12. The method of claim 8, whereby said dome shaped eminence means, provides urging of the human hand to assume a substantially improved biomechanical alignment position of the bone and soft-tissue elements, substantially supporting the palmar aspect of the hand, from the thenar and hypothenar pads to the tips of the thumb and fingers, including the apex portion of the palmar arch, consisting of the regions that include the joints located at the head of the metacarpals of the four fingers, and the base of the proximal phalanx of the four fingers, as well as the proximal and distal phalanx of the thumb, further including the distal aspect of the metacarpal shafts and heads of the metacarpals themselves, and the first metacarpophalangeal joint of the thumb.

13. The method of claim 8, whereby said dome-shaped eminence means provides a means for performing specific hand exercises by positioning the first metacarpophalangeal joint of a hand on the surface of the device, and performing a series of simple flexion, extension, abduction, adduction, and rotation exercises of the thumb, thereby strengthening the surrounding soft-tissue elements.

14. The method of claim 8, whereby said dome-shaped eminence can be placed on various surfaces, including a desk, a bed, the floor, or a table, whereby support for the hand is provided during various activities of living.

15. A human hand arch support instrument means comprising a dome-shaped protuberance means, shaped to substantially conform the palmar aspect of the human hand, whereby the human hand arch region is maintained in an improved, arched, or dome shaped anatomical position, providing support to the bone and soft-tissue elements of the palmar aspect of the human hand, when the hand is resting on said arch support instrument, which is placed on a relatively flat surface.

16. The instrument of claim 15 wherein said dome-shaped protuberance means is composed of a sufficiently resilient, cushioned material.

17. The instrument of claim 15 wherein said dome-shaped protuberance means is covered by a plurality of raised bumps, whereby hand grip and comfort is substantially improved.

18. The instrument of claim 15 whereby said dome-shaped protuberance means provides a means for performing specific hand exercises by positioning the first metacarpophalangeal joint of a hand on the surface of the device, and performing a series of simple flexion, extension, abduction, adduction, and rotation exercises of the thumb, thereby strengthening the surrounding soft-tissue elements.

19. The instrument of claim 15 whereby said dome-shaped protuberance means provides support for the length of the hand, substantially supporting the palmar aspect of the hand, from the thenar and hypothenar pads to the tips of the thumb and fingers, including the apex portion of the palmar arch, consisting of the regions that include the joints located at the head of the metacarpals of the four fingers, and the base of the proximal phalanx of the four fingers, as well as the proximal and distal phalanx of the thumb, further including the distal aspect of the metacarpal shafts and heads of the metacarpals themselves, and the first metacarpophalangeal joint of the thumb, whereby human respiratory ease is relatively improved.

20. The instrument of claim 15 whereby said dome-shaped protuberance means can be placed on various surfaces, including a desk, a bed, a floor, or a table, whereby support for the human hand is provided during various activities of living, further including usage of the said instrument to support the hand that is opposite to the hand that may be using a computer mouse, whereby said instrument provides support, urging improved alignment to the human hand, and substantially to the entire human body by improving symmetrical forces to both sides of the body through a relatively symmetrical palmar base contact of human hands with a supportive surface environment.
